(19) United States
(12) Patent Application Publication
(10) Pub. No.: US 2014/0337121 A1
(43) Pub. Date: Nov. 13, 2014

(54) METHOD FOR MEASURING THE IMPACT OF ADVERTISING ON BRAND PERCEPTION

(71) Applicants: Maurice Brandman, (US); Ruthie Brandman, Oranit (IL)

(72) Inventors: Ruthie BRANDMAN, Oranit (IL); Maurice BRANDMAN, Oranit (IL)

(21) Appl. No.: 13/890,333

(22) Filed: May 9, 2013

(51) Int. Cl. G06Q 30/02

(52) U.S. Cl. CPC G06Q 30/0245
USPC 705/14.44

(57) ABSTRACT

A method for measuring the impact of advertising on brand perception is provided. The method utilizes a computing device to compare the perception of a brand from respondents who have been exposed to an advertising campaign with a second group of respondents who have not been exposed to the advertising campaign and calculating the percentage of change in the perception of the brand, across all respondents as a result of exposure to the advertising campaign.

### RELATED APPLICATIONS

This application is a continuation in part application of U.S. application Ser. No. 12/398,254, filed Mar. 5, 2009,

### FIELD OF THE INVENTION

The present invention relates to a system and method for measuring and monitoring the effectiveness of advertising. More specifically, the present invention relates to a model system and method for measuring the impact of advertising on the perception of the brand being advertised.

### BACKGROUND OF THE INVENTION

Products and services offered by companies are commonly advertised to increase customer's awareness of a specific product or service. There are many different forms of advertising such as newspapers, billboards and advertising via the internet.

Irrespective of the form of advertising, it is difficult for the advertiser to measure the impact of advertising on the potential customer. It is specifically problematical to isolate the impact of advertising from other factors.

The effectiveness of an advertising message to an audience is important and is generally quantified by the number of people that saw a particular advertisement in a given media.

There are many different methods for determining the effectiveness of advertising, for example.

Generally, in order to determine the effectiveness of an advertising campaign, it is necessary to conduct two surveys—one survey before the campaign and one after the campaign—and compare results. Other existing models require a simulation in laboratory or a tested region or channel in order to analyze the effectiveness of the advertisement.

Furthermore, existing methods are prone to errors since they do not accurately gauge the net impact of the advertising unaffected by other factors. They do not isolate the actual exposure to the given campaign from exposure to other influencing factors such as other campaigns of the brands or the competition.

A need, therefore, exists for providing a system and a method for monitoring and measuring the effectiveness of advertising that isolates the impact of particular advertising campaign from other factors.

### SUMMARY OF THE INVENTION

The present invention relates to a model that isolates the impact of advertising from other factors, after the advertising has been aired in real life.

The objective of the model may be summarized as follows:
To measure the scope of change that the advertising campaign has created in the perception of the brand in the target audience. The change may be positive or negative and is presented as a percentage of total target market.
To measure this separately for each of the brand's attributes.
To isolate other interfering biases and factors, such as other campaigns, marketing tools and respondents' biases.

There is thus provided, a method for measuring the impact of advertising on brand perception. The method utilizes a computing device to perform the steps of comparing the perception of a brand from a first plurality of respondents who have been exposed to an advertising campaign with a second plurality of respondents who have not been exposed to the advertising campaign; and calculating the percentage of change in the perception of the brand as a result of exposure to the advertising campaign.

Furthermore, the step of comparing includes the step of conducting a survey on a representative sample of a target audience, the survey being conducted during or immediately after the advertising campaign. The target audience includes the first and second plurality of respondents.

Furthermore, the step of comparing further includes the steps of defining a statistic set; for the first plurality of respondents, compiling a first total of the number of respondents who meet the criteria of the defined statistic set and who have seen the advertisement and compiling a second total of the number of respondents who do not meet the criteria of the defined statistic set and who have seen the advertisement; and for the second plurality of respondents, compiling a third total of the number of respondents who meet the criteria of the defined statistic set and who have not seen the advertisement and compiling a fourth total of the number of respondents who do not meet the criteria of the defined statistic set and who have not seen the advertisement. The statistic set may include one of a group including brand users, gender, age and social strata. FIG. 1 illustrates the process wherein usage of the brand defines the statistic set.

Furthermore, the step of comparing the perception of a brand further includes the step of applying an attitudinal scale to the perception of the brand for each of the respondents in each of the first and second plurality of respondents.

Furthermore, the step of calculating the percentage of change includes the steps of calculating the expected perception of the first plurality of respondents who have been exposed to the advertising campaign; calculating the total perception of the brand based on the calculated expected perception of the first plurality of respondents plus the observed perception of the second plurality of respondents who were not exposed to the advertising campaign; and calculating the relationship between the expected and the observed results, thereby to derive the percentage of change in the perception of the brand. This process is illustrated in FIG. 2.

Furthermore, the step of calculating expected perception includes the steps of calculating the expected perception of the first plurality of respondents who have been exposed to the advertising campaign based on the observed perception of persons who did not see the advertisement.

Furthermore, the percentage of change in the perception of the brand as a result of exposure to the advertising campaign may then be calculated, in accordance with the following equation:

$$\% Change = 100 \times \frac{\sum ( {n}^{A} , {n}^{B} , {n}^{C} , {n}^{D} ) - \sum ( {E}^{A} , {E}^{B} , {E}^{C} , {E}^{D} )}{\sum ( {E}^{A} , {E}^{B} , {E}^{C} , {E}^{D} )}$$

where: n^{A}=observed perception of respondents who meet the criteria of the defined statistic set and who have seen the advertising campaign; n^{B}=observed perception of respondents who meet the criteria of the defined statistic set who have not seen the advertising campaign; n^{C}=observed perception of respondents who do not meet the criteria of the defined statistic set and who have seen the advertising campaign; and n^{D}=observed perception of respondents who do not meet the criteria of the defined statistic set and who have not seen the advertising campaign; and

where E^{A}=expected perception of respondents who meet the criteria of the defined statistic set and who have seen the advertising campaign; E^{B}=n^{B}; E^{C}=expected perception of respondents who do not meet the criteria of the defined statistic set and who have seen the advertising campaign; and E^{D}=n^{D}.

### BRIEF DESCRIPTION OF THE DRAWINGS

The present invention will be understood and appreciated more fully from the following description taken in conjunction with the appended drawings in which:

FIG. 1 is a schematic flow chart illustrating the method of classification of the survey data for measuring the impact of an advertising campaign on a sample of respondents, in accordance with an embodiment of the present invention;

FIG. 2 is a schematic flow chart illustration of the model for analyzing the results of the research survey used which illustrates the computation formulae for calculating the percentage change in the respondents' answers to an attribute question, used with the method of FIG. 1; and

FIG. 3 is an example illustrating the Change Computation formulae in FIG. 2 to calculated percentage change in respondents' answers to an attribute question with positive or negative response.

### DESCRIPTION OF THE INVENTION

The present invention relates to a model and method for measuring the impact of advertising on the interviewees' perceptions of the brand which is the subject of an advertising campaign.

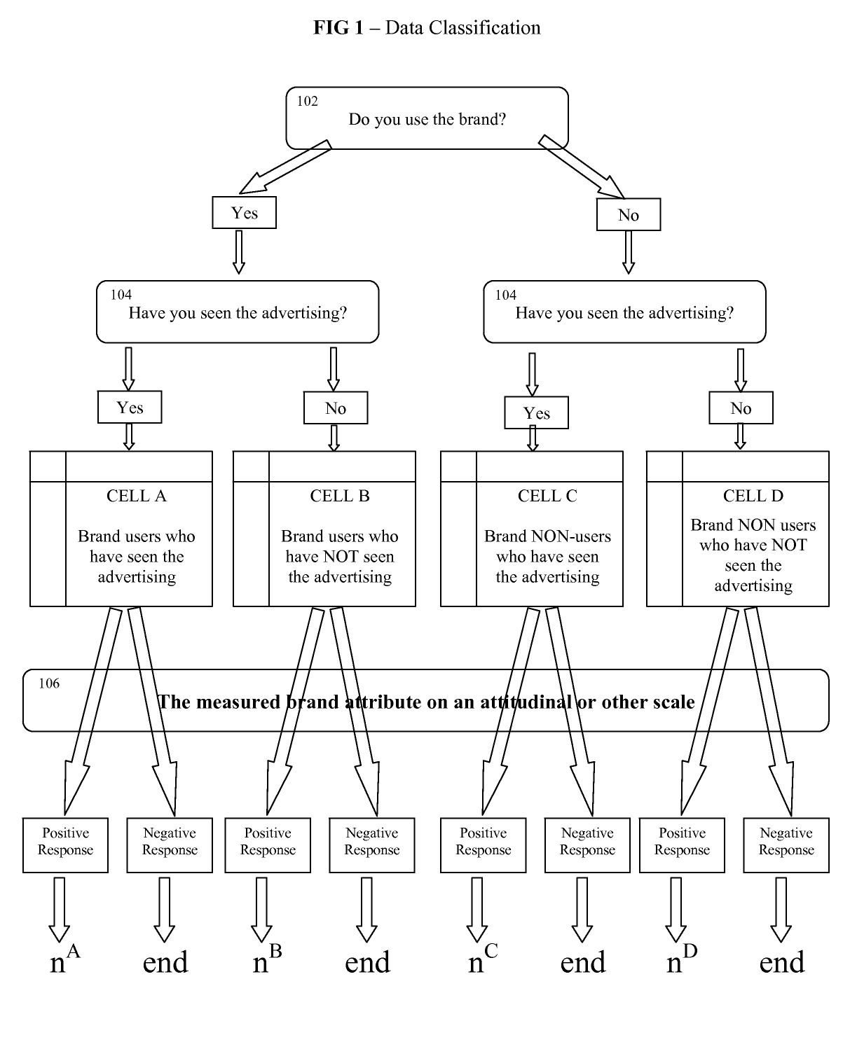

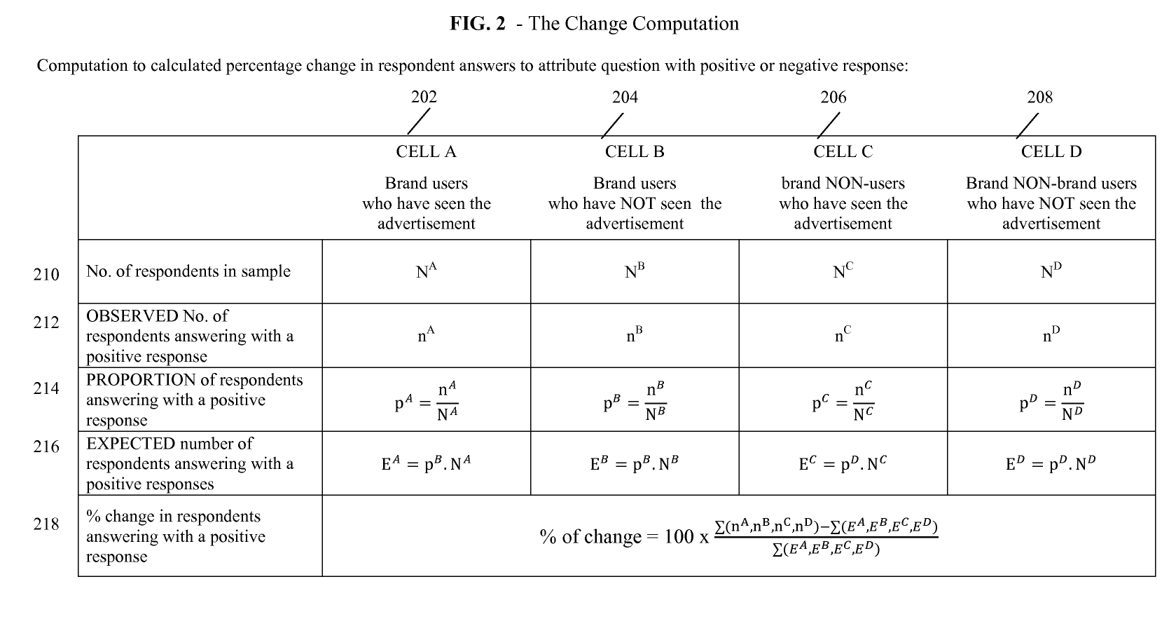

Reference is now made to FIGS. 1 and 2. FIG. 1 is a schematic flow chart illustration of the method of classification of the survey data for measuring the impact of advertising on brand perception, in accordance with an embodiment of the present invention. FIG. 2 is a schematic flow chart illustration of the analytical model for analyzing the results of the research survey.

### The Model

The model is based on two key elements:
A research survey on a representative sample of the target audience which is conducted at one time slice during or immediately after the advertising campaign.

The model takes into account the bias caused by the respondents. There are variables which affect the brand's perception. For example, users of a brand have a different attitude toward the brand than non-users. There are many other variables which affect perception, such as—but not limited to—gender (male/female), age, social strata, and frequency of using the category, for example. The model identifies which single variable or group of variables are significant in defining attitude and which should be used to measure the impact of the advertising campaign. For the purposes of example, this variable is hereinafter referred to as the ‘statistic set’. The term ‘non-statistic set’ is used to define persons excluded from the ‘statistic set’. Thus, ‘statistic set’/′non-statistic set′ may refer to “brand users” versus “brand non-users”

Thus, there are four separate groups, which may have different perceptions of a brand (as shown in FIG. 1), as follows:

cell A. ‘statistic set’ that have seen the advertising campaign;

cell B. ‘statistic set’ that have not seen the advertising campaign;

cell C. ‘non-statistic set’ who have seen the advertising campaign; and

cell D. ‘non-statistic set’ that have not seen the advertising campaign.

The impact of the advertising campaign may be measured in a single survey after it has been aired in real life by analyzing the four groups of respondents. The model isolates the respondents' actual exposure to a specific campaign.

### Research Tools

Different research tools may be used. In an embodiment of the invention, the following non-limiting examples may be utilized in the survey:

1. Perception of the Brand
This perception of the brand may be measured by any type of attitudinal scale. For example, the interviewee may be requested to “rate his/her overall attitude toward brand “X” on a scale of 1-10, where 10 means “very positive” and 1 means “very negative”. This method may be applied for various variables for brands, companies and persons. Any other type of scale or tool, known in the art, which measures attitude may be used.

2. Exposure to the Advertising
In order to determine whether the interviewee has seen the campaign, a description of the advertising may be read to the interviewees—without mentioning the brand or company name—and the interviewees are asked to confirm if they recognize the brand. If the answer is positive, they are then requested to name the brand the campaign is advertising. Other formats for testing brand exposure, known in the art, may also be utilized.

3. Brand Usage
To determine whether they are brand users, interviewees may be asked to specify if they use this brand and how frequently they use it.

Reference is now made to FIG. 1, which is a schematic flow chart illustration of the first step of the method for researching the impact of an advertising campaign on a sample of respondents. For the purposes of example only and for clarity, a single variable of “brand users” versus “brand non-users” is used to define the ‘statistic set’/′non-statistic set′.

The interviewees are asked questions regarding their exposure to the advertising campaign and their use of the brand and their attitude toward the brand.

The interviewee is asked whether he uses the brand (query box 102).

Each respondent is also asked whether he has seen the advertising (query box 104).

Each respondent is also asked to rate his/her overall attitude toward the advertised brand on a positive-negative scale (query box 106).

The responses to the survey are distributed between the four cells A, B, C, and D, according to the interviewees answers, as follows:
cell A. brand users (statistic set′) who have seen the advertising;
   respondents who have answered “YES” to questions 102 and 104. This cell is then split between those who hold positive attitude to question 106 (n^{A}) and those who responded negatively to the brand (end).
cell B. brand users who have not seen the advertising;
   respondents who have answered “YES” to question 102 and “NO” to question 104. This cell is then split between those who hold positive attitude to question 106 (n^{B}) and those who responded negatively to the brand (end).
cell C. brand non-users (non-statistic set′) who have seen the advertising;
   respondents who have answered “NO” to questions 102, and “YES” to question 104. This cell is then split between those who hold positive attitude to question 106 (n^{C}) and those who responded negatively to the brand (end).
cell D. brand non users who have not seen the advertising;
   respondents who have answered “NO” to questions 102 and 104. This cell is then split between those who hold positive attitude to question 106 (n^{D}) and those who responded negatively to the brand (end).

### The Change Computation

The present invention measures the change impacted by exposure to the advertising campaign. Reference is now made to FIG. 2, which is a schematic illustration, in tabular format, of the model for analyzing the results of the research survey for each of four cells A, B, C, and D (columns 202, 204, 206 and 208 respectively). The number of respondents in the sample N^{A}, N^{B}, N^{C} and N^{D}—for each four cells A, B, C, and D, respectively is shown in row 210.

The calculation steps are as follows:
Step 1: The observed perception, shown in row 212, for users (cells A and B) and non-users (cells C and D) of the advertised brand is calculated as follows:
   Σ(n^{A},n^{B},n^{C},n^{D})
   The observed No. of respondents answering with a positive response; n^{A}, n^{B}, n^{C} and n^{D}—for each four cells A, B, C, and D, (see FIG. 1) respectively is shown in row 212
Step 2:
The proportion of respondents answering with a positive response; p^{A}, p^{B}, p^{C} and p^{D}—for each four cells A, B, C, and D, respectively is shown in row 214, where

$${p}^{A} = \frac{{n}^{A}}{{N}^{A}} ; {p}^{B} = \frac{{n}^{B}}{{N}^{B}} ; {p}^{C} = \frac{{n}^{C}}{{N}^{C}} ; {p}^{D} = \frac{{n}^{D}}{{N}^{D}}$$

Step 3: The expected perception, shown in row 216, for persons who saw the advertisement are calculated, based on the observed perception of persons who did not see the advertisement (E^{B}=p^{B}·N^{B} in group B and E^{D}=p^{D}·N^{D} in group D).
   Thus, the expected perceptions of persons who saw the advertisement are shown as E^{A}=p^{E}·N^{A} and E^{C}=p^{D}·N^{C}
Step 4: The total expected perception is represented as:
   Σ(E^{A},E^{B},E^{C},E^{D})
Step 5: The percentage of change in the perception of the brand as a result of exposure to the advertising campaign, shown in row 218, may then be calculated as follows:

$$\% Change = 100 \times \frac{\sum ( {n}^{A} , {n}^{B} , {n}^{C} , {n}^{D} ) - \sum ( {E}^{A} , {E}^{B} , {E}^{C} , {E}^{D} )}{\sum ( {E}^{A} , {E}^{B} , {E}^{C} , {E}^{D} )}$$

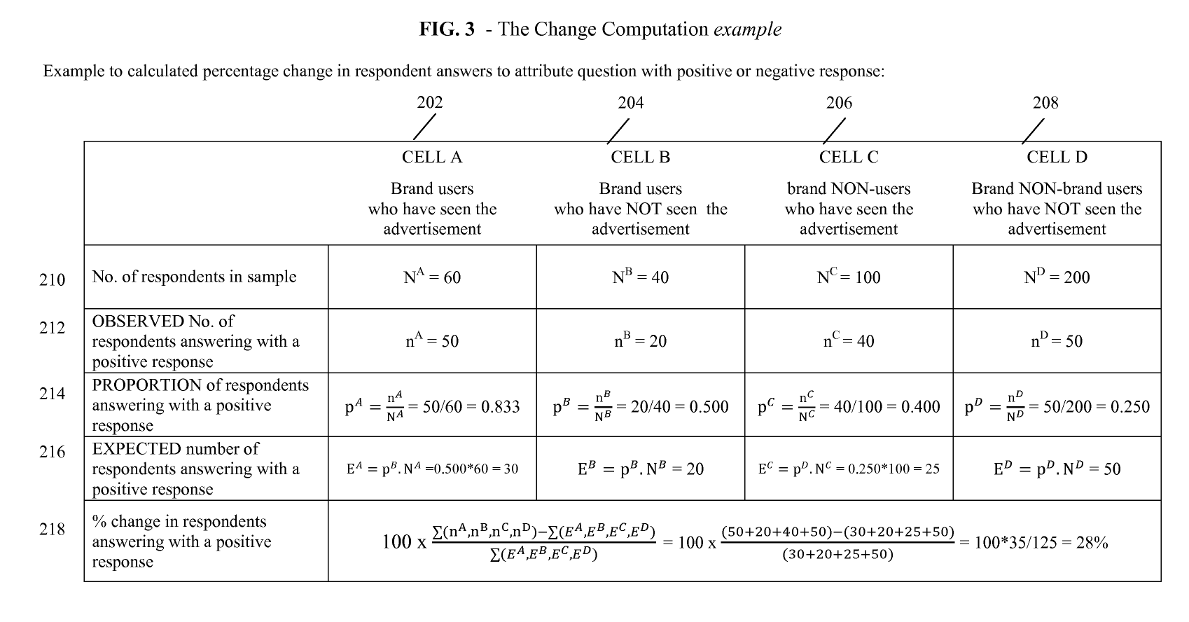

Reference is made to FIG. 3 which is an example of applying the change computation. In this example, there is a demonstration of the calculated percentage change in respondents' answers to a survey on an attribute question with positive or negative scale whereas the statistic set is users versus non users of that brand.

As an example, assuming a representative sample of the target audience comprising 400 persons, split into the four groups (A, B, C and D). Let's assume that N^{A}=60, N^{B}=40, N^{C}=100, and N^{D}=200 [such that Σ(N^{A},N^{B},N^{C},N^{D})=400]

Then assuming that the number of respondents answering with a positive response is correspondingly 50, 20, 40 and 50 in each of groups A, B, C and D, represented by n^{A}=50, n^{B}=20, n^{C}=40 and n^{D}=50. [Σ(n^{A},n^{B},n^{C},n^{D})=160].

Thus, the proportion of respondents answering with a positive response (row 214) in each of groups A, B, C and D, respectively using mathematical notation is:

$${p}^{A} = \frac{{n}^{A}}{{N}^{A}} = 50 \text{/} 60 = 0 , 833 ; {p}^{B} = \frac{{n}^{B}}{{N}^{B}} = \frac{20}{40} = 0.500 ;$$

$${p}^{C} = \frac{{n}^{C}}{{N}^{C}} = 40 \text{/} 100 = 0.400 ; {p}^{D} = \frac{{n}^{D}}{{N}^{D}} = 50 \text{/} 200 = 0 \; 250$$

The expected number of respondents answering with a positive response is thus: E^{A}=p^{B}·N^{A}=0.500*60=30; E^{B}=p^{B}·N^{B}=20; E^{C}=p^{D}·N^{C}=0.250*100=25; E^{D}=p^{D}·N^{D}=50

$$\begin{matrix}Thus , the percent change = 100 \times \frac{\begin{matrix}\sum ( {n}^{A} , {n}^{B} , {n}^{C} , {n}^{D} ) - \\ \sum ( {E}^{A} , {E}^{B} , {E}^{C} , {E}^{D} )\end{matrix}}{\sum ( {E}^{A} , {E}^{B} , {E}^{C} , {E}^{D} )} \\ = 100 \times \frac{( 50 + 20 + 40 + 50 ) - ( 30 + 20 + 25 + 50 )}{( 30 + 20 + 25 + 50 )} \\ = 100 * 35 \text{/} 125 \\ = 28 \%\end{matrix}$$

### ADVANTAGES OF THE PRESENT INVENTION

Thus, in contrast to prior art applications, the present invention is the only model that measures the impact of advertising in a single survey after it has been aired in real life and not in a simulated or tested region. Prior art models generally need to run two surveys and compare results, with one survey before the campaign and one after the campaign. Other existing models require a simulation in laboratory or a tested region or channel in order for analysis.

Furthermore, the model of the present invention isolates the change impacted by actual exposure to advertising, in contrast to “before-after” model that assumes exposure in the period between measurements. Other prior art models do not isolate the actual exposure to the given campaign from exposure to other campaigns of the brands or the competition. A further advantage of the present invention over existing models is that it is free from any other interfering marketing activities of the brand or its competitors which occurred concurrently with the campaign.

It will be further appreciated that the present invention is not limited by what has been described hereinabove and that numerous modifications, all of which fall within the scope of the present invention, exist. Rather the scope of the invention is defined by the claims, which follow:

1. A method for measuring the impact of advertising on brand perception on a target audience, the method comprising utilizing a computing device to perform the steps of:
selecting a representative sample from the target audience;
comparing the perception of a brand from a first plurality of respondents from the entire representative sample, said first plurality of respondents comprising a first group who have seen an advertising campaign for said brand, with a second plurality of respondents from the entire representative sample, said second plurality of respondents comprising a second group who have not seen said advertising campaign, wherein the two pluralities of respondents comprise the entire representative sample; and
calculating the percentage of change in the perception of the brand by the entire representative sample as a result of the advertising campaign;
wherein the perception of the brand and the impact of the advertising campaign is calculated as a percentage change in the proportion of the entire representative sample for which a specific response is recorded as a result of the advertising campaign.

2. The method of claim 1, wherein said step of comparing comprises the step of:
conducting a survey on the entire representative sample, said survey being conducted during or immediately after the advertising campaign at one point in time, wherein said entire representative sample comprises said first and second plurality of respondents.

3. The method of claim 1 wherein said step of comparing further comprises the steps of:
defining a statistic set for said first and second plurality of respondents;
for said first plurality of respondents, compiling a first total of the number of respondents who meet the criteria of the defined statistic set and who have seen the advertisement and compiling a second total of the number of respondents who do not meet the criteria of the defined statistic set and who have seen the advertisement; and
for said second plurality of respondents, compiling a third total of the number of respondents who meet the criteria of the defined statistic set and who have not seen the advertisement and compiling a fourth total of the number of respondents who do not meet the criteria of the defined statistic set and who have not seen the advertisement.

4. The method of claim 3, wherein the statistic set comprises one of a group including brand users, gender, age and social strata.

5. The method of claim 3, wherein the step of comparing the perception and attitude towards a brand further comprises the step of:
for each of the respondents in each of said first and second plurality of respondents, applying an attitudinal scale relating to the brand.

6. The method of claim 1 wherein said step of calculating the percentage of change comprises the steps of:
calculating the expected perception of the brand for the first plurality of respondents who have seen said advertising campaign, based on the observed perception of the brand from the second plurality of respondents who have not seen said advertising campaign; and
calculating the relationship between the expected and the observed results, thereby to derive the percentage of change in the perception and attitude towards the brand.

7. The method of claim 1, wherein the percentage of change in the perception of the brand as a result of the advertising campaign is calculated, as follows:
$$\% change = 100 * \frac{\sum ( {n}^{A} , {n}^{B} , {n}^{C} , {n}^{D} ) - \sum ( {E}^{A} , {E}^{B} , {E}^{C} , {E}^{D} )}{\sum ( {E}^{A} , {E}^{B} , {E}^{C} , {E}^{D} )}$$
where: n^{A}=the observed number of pre-defined responses from the first plurality of respondents who have seen the advertising campaign; n^{B}=the observed number of pre-defined responses from the first plurality of respondents—who have not seen—the advertising campaign; n^{C}=the observed number of pre-defined responses from the second plurality of respondents who have seen the advertising campaign; and n^{D}=the observed number of pre-defined responses from the second plurality of respondents who have not seen the advertising campaign;
where E^{A}=expected number of pre-defined responses of the first plurality of respondents-who have seen the advertising campaign; and
E^{C}=expected number of pre-defined responses of the second plurality of respondents who have seen the advertising campaign.
